(19) United States
(12) Patent Application Publication
(10) Pub. No.: US 2008/0000940 A1
(43) Pub. Date: Jan. 3, 2008

(54) Bicycle rack connection to roof rack of vehicles

(76) Inventor: Chiu-Kuei Wang, Dajia Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,390

(22) Filed: Jun. 19, 2007

(30) Foreign Application Priority Data
Jun. 29, 2006 (TW) 095211386

(51) Int. Cl. B60R 9/10

(52) U.S. Cl. 224/319

(57) ABSTRACT

A bicycle rack includes a front bar, a rear bar and a plurality of longitudinal bars connected between the front and rear bars. A plurality of connection units are used to connect the bicycle rack to a roof rack of a vehicle. A first securing device includes a securing frame which is connected to the front bar and two quick release sets are connected on two sides of the securing frame. The two quick release sets are used to secure two legs of a front fork of a bicycle. A second securing device is connected to the rear bar and includes a support on which a rear wheel of the bicycle is arranged and a securing strap is used to secure the rear wheel of the bicycle on the support.

### FIELD OF THE INVENTION

The present invention relates to a bicycle rack connected to roof rack of vehicles and the bicycle can be securely fixed at three points.

### BACKGROUND OF THE INVENTION

A conventional bicycle rack generally includes a first type which is attached to rear end of vehicles and a second type which is connected on roof rack of vehicles. The bicycle rack attached to rear end of vehicles protrudes from the rear end of the vehicle and might affects the driver to see the traffic conditions via the rear windshield. The bicycle rack may hit objects when parking by way of tail-in. The second type of the bicycle rack 80 connected to the roof rack and disclosed in FIG. 5 wherein the roof rack includes longitudinal rails 81 with multiple transverse rails 82 connected between the longitudinal rails 81, a support 83 is connected between one of the transverse rails 82 so that the front wheel 840 and the rear wheel 84 are supported on the support 83 and are secured by two securing members 85. A positioning device 86 has one end pivotably connected to the transverse rail 82 and the other end of the positioning device 86 is hooked to the down tube 88 of the bicycle to position the bicycle. However, the three securing points are located substantially at the same longitudinal axis so that the bicycle may shake to right and left ways. Besides, the height of the bicycle on the roof of the bicycle is too high so that the weight of center of the bicycle is high which makes the bicycle unstable.

The present invention intends to provide a bicycle rack connected to roof rack of vehicles wherein the front wheel of the bicycle is removed and the two legs of the front fork are secured by two quick release devices and the rear wheel is secured by a securing strap. The three securing points to the bicycle are not located at the same axis so that the bicycle can be well positioned.

### SUMMARY OF THE INVENTION

The present invention relates to a bicycle rack that comprises a front bar, a rear bar and a plurality of longitudinal bars connected between the front and rear bars. A plurality of connection units are connected to the bicycle rack so as to be connected to a roof rack of a vehicle. A first securing device includes a securing frame which is connected to the front bar and two quick release sets are connected on two sides of the securing frame so as to secure two legs of a front fork of a bicycle. A second securing device is connected to the rear bar and includes a support which supports a rear wheel of the bicycle and a securing strap is connected to the support to secure the rear wheel of the bicycle to the support.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle rack of the present invention;

FIG. 2 shows that the bicycle rack of the present invention is connected to a roof rack of a vehicle;

FIG. 3 shows two legs of the front fork of the bicycle are secured by the quick release sets of the bicycle rack of the present invention;

FIG. 4 shows a storage box is received in the recessed area of the longitudinal bars of the bicycle rack of the present invention, and

FIG. 5 shows a conventional bicycle rack connected to roof rack of a vehicle.

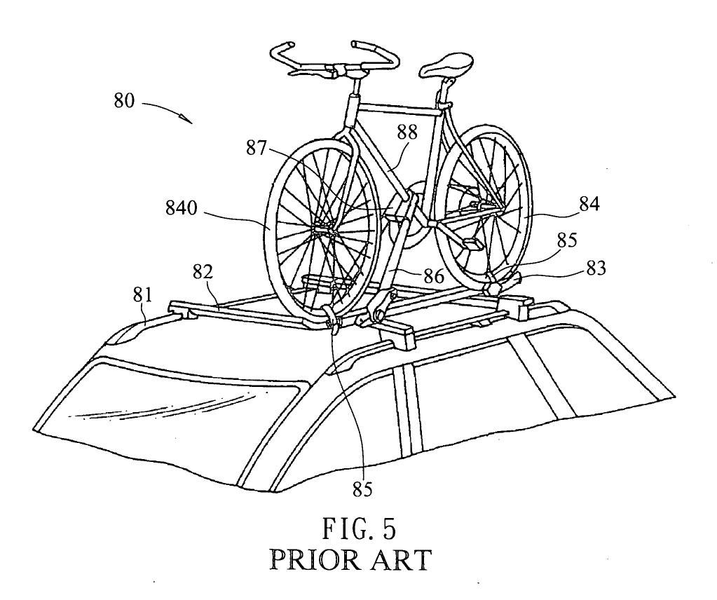

### DETAILED DESCRIPTION OF THE PREFERRED EMBODIMENT

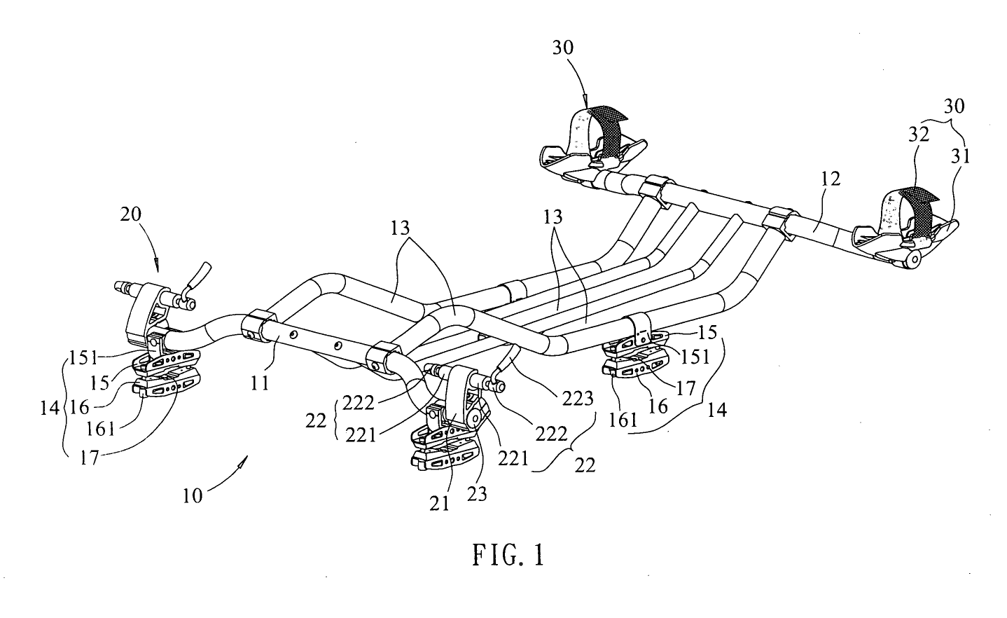

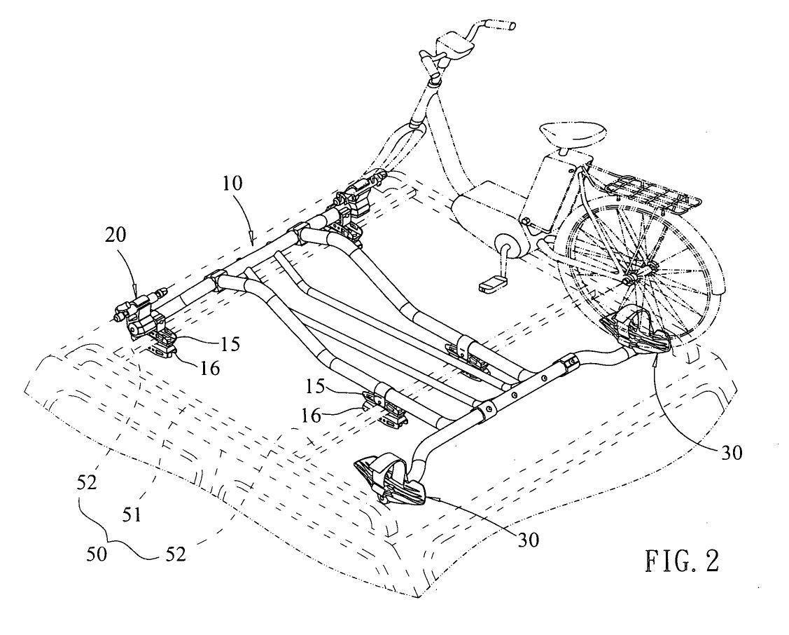

Referring to FIGS. 1 to 3, the bicycle rack 10 of the present invention comprises a front bar 11, a rear bar 12 and a plurality of longitudinal bars 13 connected between the front and rear bars 11, 12. Four connection units 14 are connected to two of the longitudinal bars 13 and two ends of the front bar 11 so as to connect the bicycle rack 10 to a roof rack 50 of a vehicle. The roof rack 50 generally includes two longitudinal rails 51 fixed on the roof of the vehicle and the transverse rails 52 are connected between the longitudinal rails 51. Each of the connection units 14 includes a top part 15 and a bottom part 16 which is connected to the top part 15 by bolts 161. The top part 15 is connected to the transverse bar 13 or the front bar 11 by a connection member 151. A slot 17 is defined between the top part 16 and the bottom part 16 so that the transverse rail 52 of the roof rack 50 is clamped in the slot 17.

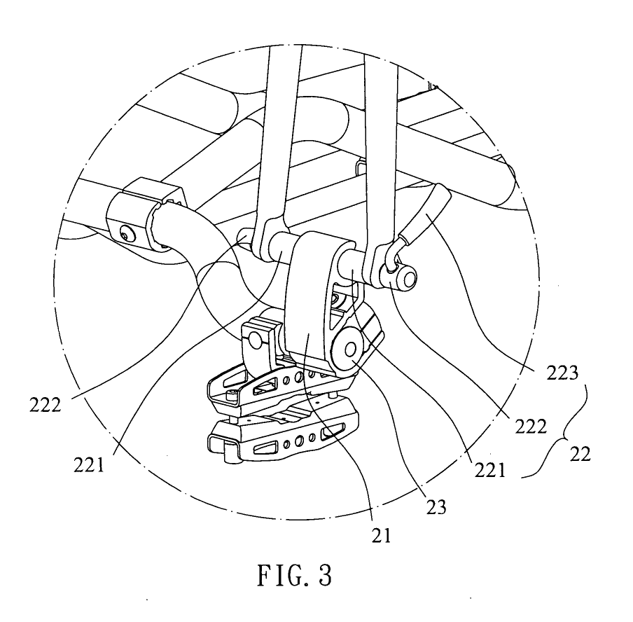

Two first securing devices 20 are connected on the two ends of the front bar 11 and each of the first securing devices 20 has a securing frame 21 which is connected to the front bar 11 and two quick release sets 22 are connected on two sides of the securing frame 21. Each quick release set 22 includes a fixed part 221 fixed to the securing frame 21 and a movable part 222 is movably connected to the fixed part 221. A lever 223 extends from the movable part 222 so as to operate the movable part 222 to move toward the fixed part 221 to clamp the leg of the front fork as shown in FIG. 3.

Two second securing devices 30 are connected to two ends of the rear bar 12 and each second securing device 30 includes a support 31 on which a rear wheel of the bicycle is supported. A securing strap 32 is connected to the support 31 and secures the rear wheel of the bicycle to the support 31. An end cap 23 is connected to each of the two ends of the front bar 11 to prevent the securing frame 21 from disengaging from the front bar 11.

The bicycle secured on the bicycle rack 10 with the front wheel removed so that the height that the bicycle on the roof o the vehicle is reduced. The three secured points of the bicycle on the bicycle rack 10 are not located at the same axis and this ensures the bicycle can be secured more secured when compared the bicycle is secured on the conventional bicycle rack.

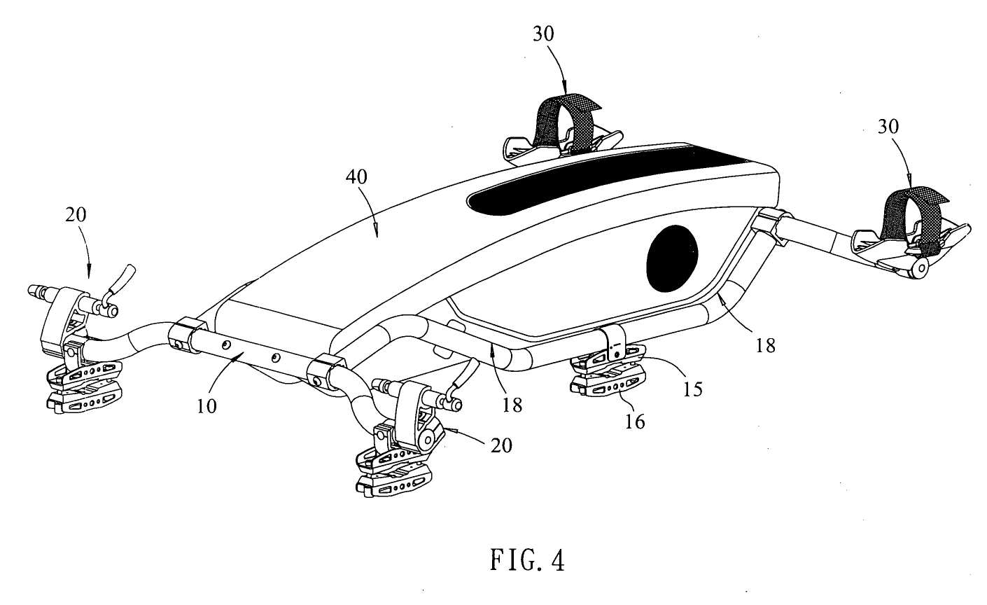

FIG. 4 shows another embodiment of the bicycle rack 10, wherein the longitudinal bars 13 are bent to form a recessed area 18 in which a storage box 40 is engaged.

While we have shown and described the embodiment in accordance with the present invention, it should be clear to those skilled in the art that further embodiments may be made without departing from the scope of the present invention.

What is claimed is:

1. A bicycle rack comprising:
a front bar, a rear bar and a plurality of longitudinal bars connected between the front and rear bars, a plurality of connection units connected to the bicycle rack which is adapted to be connected to a roof rack of a vehicle;
a first securing device having a securing frame which is connected to the front bar and two quick release sets connected on two sides of the securing frame, the two quick release sets adapted to secure two legs of a front fork of a bicycle, and
a second securing device connected to the rear bar and having a support which is adapted to support a rear wheel of the bicycle, a securing strap connected to the support and adapted to secure the rear wheel of the bicycle to the support.

2. The bicycle rack as claimed in claim 1, wherein the longitudinal bars are bent to form a recessed area in which a storage box is engaged.

3. The bicycle rack as claimed in claim 1, wherein each of the connection units includes a top part and a bottom part which is connected to the top part by bolts, the top part is connected to the transverse bar by a connection member, a slot is defined between the top part and the bottom part so as to be adapted to clamp the transverse rail of the roof rack.

4. The bicycle rack as claimed in claim 1, wherein an end cap is connected to an end of the front bar to prevent the securing frame from disengaging from the front bar.

5. The bicycle rack as claimed in claim 1, wherein each quick release set includes a fixed part fixed to the securing frame and a movable part is movably connected to the fixed part, a lever extends from the movable part so as to operate the movable part to move toward the fixed part to be adapted to clamp the leg of the front fork.

6. The device as claimed in claim 1, wherein the securing frame is connected to one of two ends of the front bar.
